(19) United States
(12) Patent Application Publication
(10) Pub. No.: US 2012/0204733 A1
(43) Pub. Date: Aug. 16, 2012

(54) Cooking System

(76) Inventor: Gilbert Dennis, Mansfield, TX (US)

(21) Appl. No.: 13/027,964

(22) Filed: Feb. 15, 2011

(51) Int. Cl. A47J 37/04

(52) U.S. Cl. 99/443 C

(57) ABSTRACT

A cooking system for cooking food may include a cooking housing to house the cooking system, a conveyor cavity being defined by the cooking housing, a first endless conveyor belt being within the conveyor cavity and a second endless conveyor belt being within the conveyor cavity to cooperate with the first endless conveyor belt. The second endless conveyor belt may include a cooking plate which may cooperate with the first endless conveyor belt to transfer the food between the first endless conveyor belt and the cooking plate of the second endless conveyor belt, and the cooking system may include a first burner.

### FIELD OF THE INVENTION

The present invention relates to a conveyer oven system which may include a conveyor oven, a stove top burner, a deep frying compartment, a grease compartment and a warmer oven compartment for commercial use in which foods, such as meat, pizza, or other food items are placed on a conveyer and heated.

### BACKGROUND OF THE INVENTION

Conventionally, in fast food stores, a conveyer oven is used for heating foods such as a pizza.

The description of such a conveyer oven is disclosed in Japanese Patent Publication of Examined Application 3-3126. It includes a heating chamber for heating foods, a conveyer that penetrates the heating chamber horizontally for carrying the foods into the heating chamber, and a heating means provided in the heating chamber for heating the foods which are placed on the conveyer from the top and the bottom of the foods.

The foods are placed on the conveyer and carried into the heating chamber. While they are conveyed, the heating means blows hot air on the foods in order to heat the same. Quantity of caloric value and a conveying speed of a conveyer are set so that cooking is finished when the foods are carried out from the heating chamber.

In this kind of conveyer oven, a conveyer is set so that it penetrates the heating chamber horizontally. Therefore, an entrance port and an exit port are provided on the lateral side walls of the heating chamber.

### SUMMARY

A cooking system for cooking food may include a cooking housing to house the cooking system, a conveyor cavity being defined by the cooking housing, a first endless conveyor belt being within the conveyor cavity and a second endless conveyor belt being within the conveyor cavity to cooperate with the first endless conveyor belt.

The second endless conveyor belt may include a cooking plate which may cooperate with the first endless conveyor belt to transfer the food between the first endless conveyor belt and the cooking plate of the second endless conveyor belt, and the cooking system may include a first burner.

The cooking system may include a deep frying compartment, and the cooking system may include a conveyor grill.

The cooking housing may include a first access aperture to access the conveyor cavity, and the cooking housing may include a second access aperture to access the conveyor cavity.

The cooking system includes an auxiliary oven, and the coding system may include a warmer oven.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the cooking system of the present invention;

FIG. 2 illustrates a perspective view of the conveyor system of the present invention;

FIG. 3 illustrates a front view of the cooking system n of the present invention;

FIG. 4 illustrates a back view of the cooking system of the present invention;

FIG. 5 illustrates a perspective view of the conveyor system of the present invention;

FIG. 6 illustrates a perspective view of the cooking system of the present invention;

FIG. 7 illustrates a top view of the cooking system of the present invention;

FIG. 8 illustrates cooking plates of the present invention;

FIG. 9 illustrates a first side view of the cooking system of the present invention;

FIG. 10 illustrates a second side view of the cooking system of the present invention.

### DETAILED DESCRIPTION

Versatile Convection Veyor Oven/cooking system 100 may be designed to cook large quantities and different types of meat and other foods simultaneously for more efficient production of prepared foods. The oven may be used by a number of cooks and chefs in order to provide additional flexibility.

The Versatile Convection Veyor Oven/cooking system 100 is designed to produce large quantities and different types of cooked food and to be used by a number of chefs and cooks. This innovative product features an oven including a grill, a conveyor belt and rotating racks. Meat or other food which may be vegetables or other types of food may be first placed onto the grill, cooked briefly, and then automatically flipped over for even cooking of both sides. Meat or other food may also be placed directly onto the conveyor belt or into aluminum trays and passed through the oven until the food has been thoroughly cooked or cooked to the satisfaction of the chef or cook. Any grease produced by the food or other types of foods may fall into a provided grease trap for healthy and clean cooking. The Versatile Convection Veyor Oven/cooking system 100 may be used to cook multiple items at once, and may be used in restaurants and other similar venues,

### Advantages of the invention

Employees at venues such as restaurants or schools or other organizations that are required to produce large quantities of food in short periods of time may have difficulty doing so. Oven may be expensive to provide and consequently there may be a shortage of ovens. Additionally, different types of food may be required to be prepared in different ways and cooked to different specifications. Meats especially require attentive care to ensure that they are cooked properly. Kitchen staff members may be required to supervise multiple types of food being cooked together, while attempting to carry out specific preparation orders from the people ordering the food such as being required to be cooked well done or rare. This environment may be highly stressful for those preparing the food, inconvenient and requiring many steps. The end result may be a reduction in the amount of food prepared at a given time. The present invention provides an effective solution to these and other problems.

Versatile Convection Veyor Oven/cooking system 100 provides an efficient device for cooking large quantities of food at once. The invention may include an oven that combines a stove top, a deepfryer, and a conveyor grill with a convection rack system. It may feature two stages; the first of which being a conveyor grill containing an automatic flipper to turn over the food and to cook both sides of the meat or other item being cooked. The meat may stay on the grill before being placed onto the conveyor belt inside the oven. Once on the conveyor belt, the meat can either continue on to the other side of the oven upon completion of cooking, or it can be lifted onto a wheel rack, thus starting the second stage. The meat can sit on a tray that is angled slightly and rotates around the wheel for a set period of time. When the cooking time has ended, the tray may lower the meat back onto the conveyor belt and continue until reaching the other side. All excess grease and liquid may fall into a grease trap located below the belt, at which time the grease can be disposed of properly. The outside of the oven may also include small doors and windows, allowing users to view the cooking process and access the inside of the oven if necessary. Two meat-smoking compartments can be included on the front bottom portion of the oven. A switch on the side of the oven may activate/deactivate a light inside the oven. Also included on one side of the invention may be a four-burner stove top for manual cooking of various foods. Next to the stove top may be at least a first deep-fryer and a second deep-fryer, allowing the users for example the chefs and cooks to prepare foods which are suitable for deep frying such as French fries, chicken wings, and other traditionally fried foods. The present invention is ideal for cooking meats, but can also be used to cook pizzas and many other food items. The present invention has been described having a specific number of oven compartments, grease compartment, warmer area compartments, temperature controls, burner units, deep frying compartments and the like. These numbers can be raised or lowered in order to meet the requirements of specific situations. Some of these elements may not be present. The exact specifications may vary.

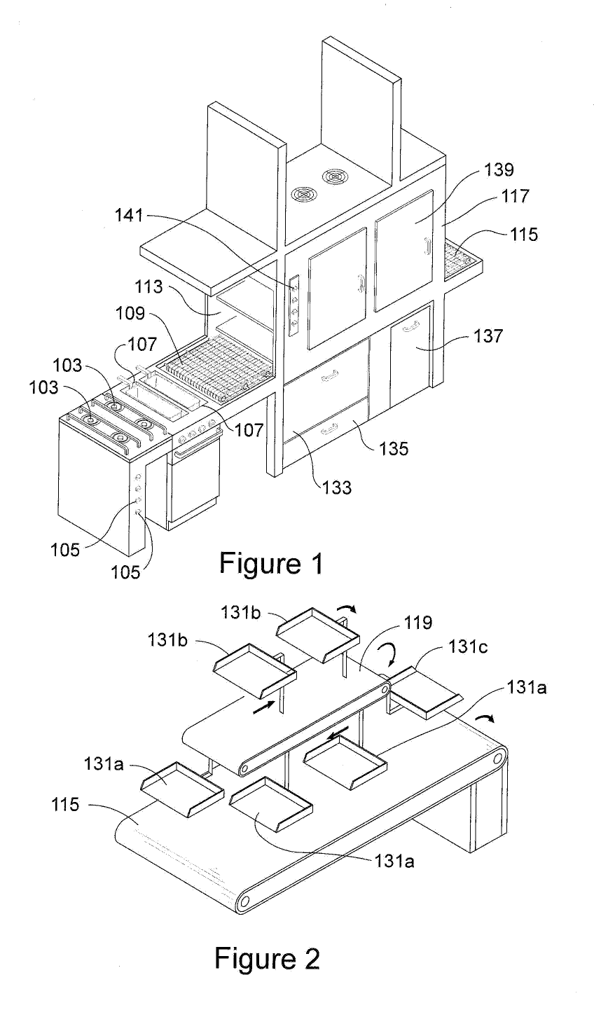

FIG. 1 illustrates a cooking system 100 of the present invention which may include a cooking housing 101 which may support burner units 103 which may be controlled by burner controls 105 which may regulate the amount of gas or electricity supplied to the burner units 103. The cooking housing 101 may include deep frying compartments 107 which may cooperate with a deep frying pan to deep fry foods such as french fries, chicken or other fried foods. The cooking system 100 may include a conveyor grill 109 which may extend from the deep frying compartment 107 to a first access aperture 111 which may be positioned on a side of the cooking housing 101 to allow access to a conveyor cavity 113. The conveyor cavity 113 as illustrated in FIG. 2 may include a duel conveyor which may include a first conveyor which may include a endless belt 115 which may rotate clockwise (or counterclockwise) to extend from the first access aperture 111 to the second access aperture 117 which may be positioned on an opposing side of the cooking housing 101. The first endless belt 115 may extend through the second access aperture 117 to provide access to the food by the users of the cooking system 100. The first endless belt 115 may cooperate with a second endless belt 119 which may support a multitude of cooking plates 131 which may rotate with the second endless belt 119. The second endless belt 119 may be positioned substantially in the center of the conveyor cavity 113. The cooking plates 131 may rotate in a first position to face the direction of travel of the second endless belt 119 as shown by cooking plates 131a or may be rotated in a second position to face the opposite direction of travel of the second endless belt as shown by cooking plates 131b. Alternatively, the cooking plates 131c may be rotated to face the second access aperture 117.

FIG. 1 additionally illustrates that the cooking system 100 may include an auxiliary oven 133 positioned beneath the conveyor cavity 113 and may include a warmer oven 135 which may be positioned beneath the auxiliary oven 133. FIG. 1 additionally illustrates a grease tray 137 to collect excess grease from the conveyor cavity 113. The housing 101 may include access door 137 which may be transparent or translucent in order to allow the interior of the conveyor cavity 113 to be seen. FIG. 1 additionally illustrates controls 141 to control the operation of the apparatus within the conveyor cavity 113.

FIG. 2 illustrates the conveyor cavity 113 which may include a duel conveyor which may include a first conveyor which may include a endless belt 115 which may rotate clockwise (or counterclockwise) to extend from the first access aperture 111 to the second access aperture 117 which may be positioned on an opposing side of the cooking housing 101. The first endless belt 115 may extend through the second access aperture 117 to provide access to the food by the users of the cooking system 100. The first endless belt 115 may cooperate with a second endless belt 119 which may support a multitude of cooking plates 131 which may rotate with the second endless belt 119. The second endless belt 119 may be positioned substantially in the center of the conveyor cavity 113. The cooking plates 131 may rotate in a first position to face the direction of travel of the second endless belt 119 as shown by cooking plates 131a or may be rotated in a second position to face the opposite direction of travel of the second endless belt as shown by cooking plates 131b. Alternatively, the cooking plates 131c may be rotated to face the second access aperture 117.

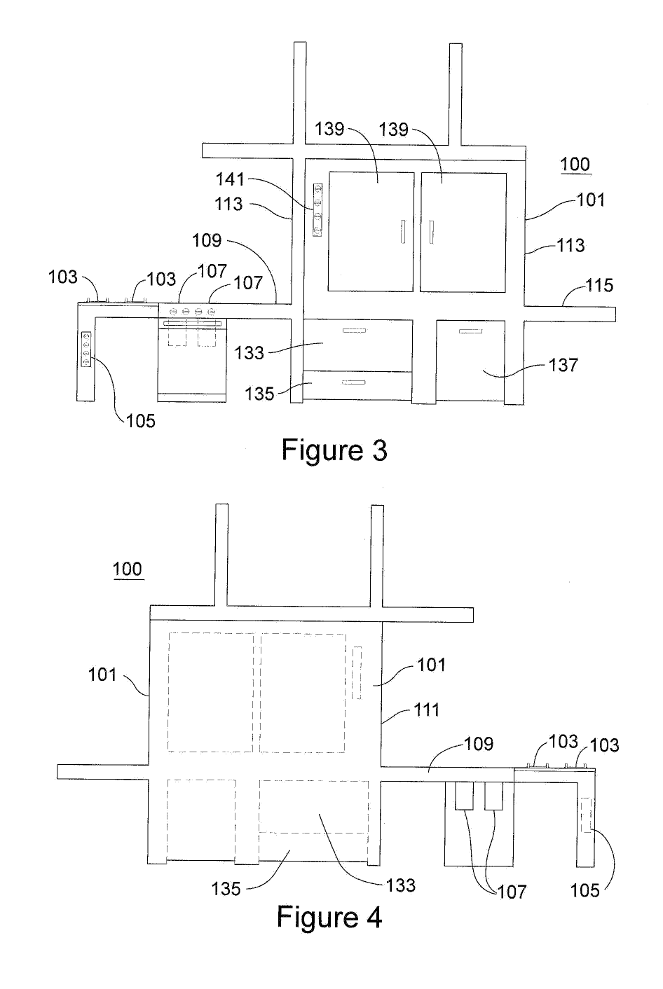

FIG. 3 illustrates a front view of the cooking system 100 of the present invention which may include a cooking housing 101 which may support burner units 103 which may be controlled by burner controls 105 which may regulate the amount of gas or electricity supplied to the burner units 103. The cooking housing 101 may include deep frying compartments 107 which may cooperate with a deep frying pan to deep fry foods such as french fries, chicken or other fried foods. The cooking system 100 may include a conveyor grill 109 which may extend from the deep frying compartment 107 to a first access aperture 111 which may be positioned on a side of the cooking housing 101 to allow access to a conveyor cavity 113. The conveyor cavity 113 as illustrated in FIG. 2 may include a duel conveyor which may include a first conveyor which may include a endless belt 115 which may rotate clockwise (or counterclockwise) to extend from the first access aperture 111 to the second access aperture 117 which may be positioned on an opposing side of the cooking housing 101. The first endless belt 115 may extend through the second access aperture 117 to provide access to the food by the users of the cooking system 100. The first endless belt 115 may cooperate with a second endless belt 119 which may support a multitude of cooking plates 131 which may rotate with the second endless belt 119. The second endless belt 119 may be positioned substantially in the center of the conveyor cavity 113. The cooking plates 131 may rotate in a first position to face the direction of travel of the second endless belt 119 as shown by cooking plates 131a or may be rotated in a second position to face the opposite direction of travel of the second endless belt as shown by cooking plates 131b. Alternatively, the cooking plates 131c may be rotated to face the second access aperture 117.

FIG. 3 additionally illustrates that the cooking system 100 may include an auxiliary oven 133 positioned beneath the conveyor cavity 113 and may include a warmer oven 135 which may be positioned beneath the auxiliary oven 133.

FIG. 4 illustrates a back view of the cooking system 100 of the present invention which may include a cooking housing 101 which may support burner units 103 which may be controlled by burner controls 105 which may regulate the amount of gas or electricity supplied to the burner units 103. The cooking housing 101 may include deep frying compartments 107 which may cooperate with a deep frying pan to deep fry foods such as french fries, chicken or other fried foods. The cooking system 100 may include a conveyor grill 109 which may extend from the deep frying compartment 107 to a first access aperture 111 which may be positioned on a side of the cooking housing 101 to allow access to a conveyor cavity 113.

FIG. 4 additionally illustrates that the cooking system 100 may include an auxiliary oven 133 positioned beneath the conveyor cavity 113 and may include a warmer oven 135 which may be positioned beneath the auxiliary oven 133.

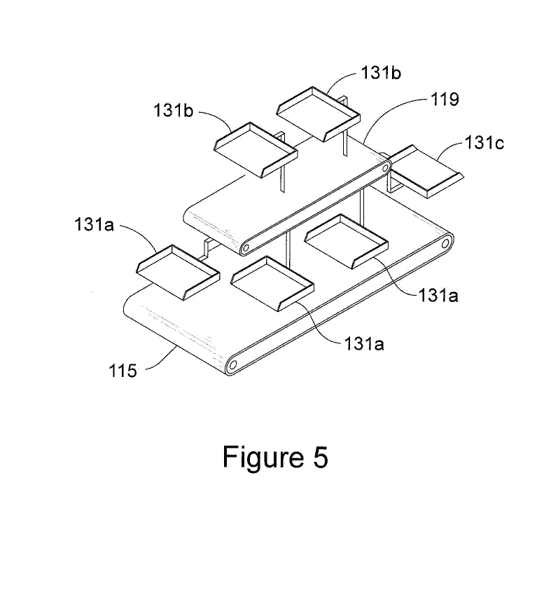

FIG. 5 illustrates the conveyor cavity 113 which may include a duel conveyor which may include a first conveyor which may include a endless belt 115 which may rotate clockwise (or counterclockwise) to extend from the first access aperture 111 to the second access aperture 117 which may be positioned on an opposing side of the cooking housing 101. The first endless belt 115 may extend through the second access aperture 117 to provide access to the food by the users of the cooking system 100. The first endless belt 115 may cooperate with a second endless belt 119 which may support a multitude of cooking plates 131 which may rotate with the second endless belt 119. The second endless belt 119 may be positioned substantially in the center of the conveyor cavity 113. The cooking plates 131 may rotate in a first position to face the direction of travel of the second endless belt 119 as shown by cooking plates 131a or may be rotated in a second position to face the opposite direction of travel of the second endless belt as shown by cooking plates 131b. Alternatively, the cooking plates 131c may be rotated to face the second access aperture 117.

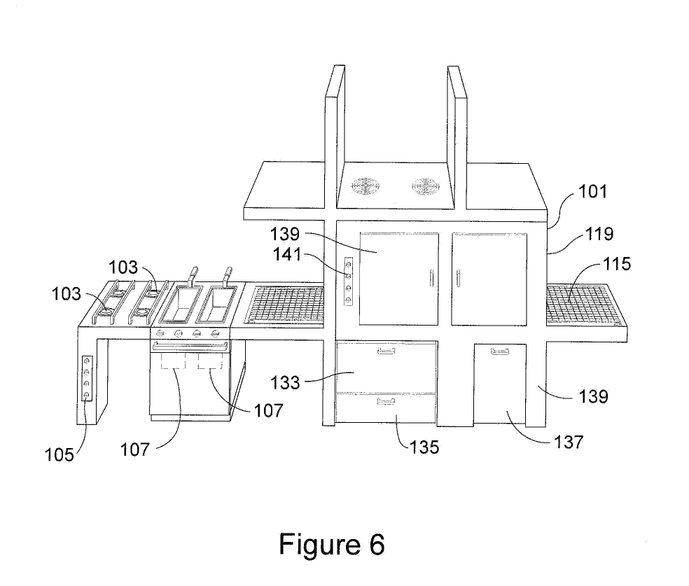

FIG. 6 illustrates a cooking system 100 of the present invention which may include a cooking housing 101 which may support burner units 103 which may be controlled by burner controls 105 which may regulate the amount of gas or electricity supplied to the burner units 103. The cooking housing 101 may include deep frying compartments 107 which may cooperate with a deep frying pan to deep fry foods such as french fries, chicken or other fried foods. The cooking system 100 may include a conveyor grill 109 which may extend from the deep frying compartment 107 to a first access aperture 111 which may be positioned on a side of the cooking housing 101 to allow access to a conveyor cavity 113.

FIG. 6 additionally illustrates that the cooking system 100 may include an auxiliary oven 133 positioned beneath the conveyor cavity 113 and may include a warmer oven 135 which may be positioned beneath the auxiliary oven 133. FIG. 1 additionally illustrates a grease tray 137 to collect excess grease from the conveyor cavity 113. The housing 101 may include access door 137 which may be transparent or translucent in order to allow the interior of the conveyor cavity 113 to be seen. FIG. 1 additionally illustrates controls 141 to control the operation of the apparatus within the conveyor cavity 113.

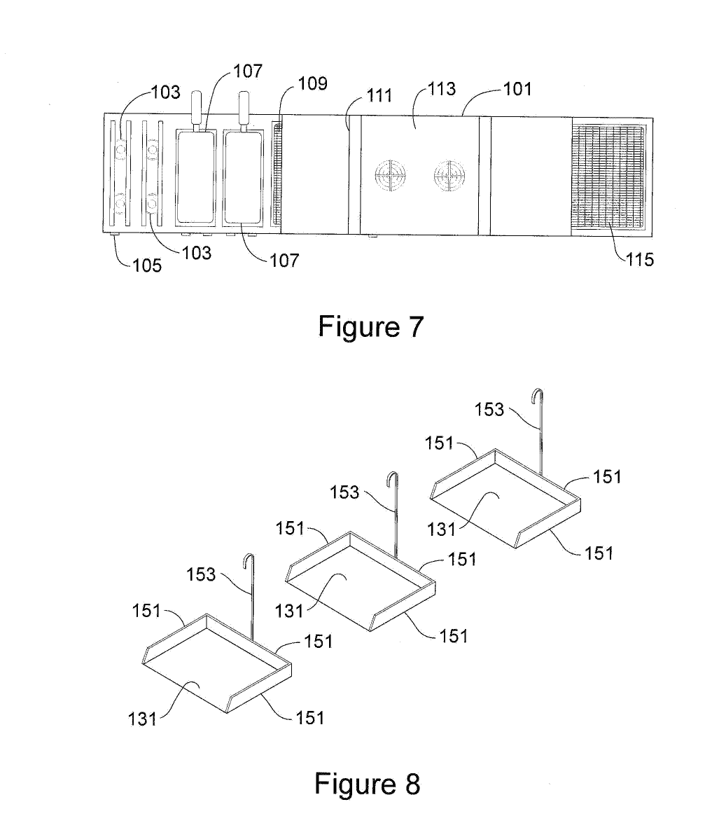

FIG. 7 illustrates a top view of the cooking system 100 of the present invention which may include a cooking housing 101 which may support burner units 103 which may be controlled by burner controls 105 which may regulate the amount of gas or electricity supplied to the burner units 103. The cooking housing 101 may include deep frying compartments 107 which may cooperate with a deep frying pan to deep fry foods such as french fries, chicken or other fried foods. The cooking system 100 may include a conveyor grill 109 which may extend from the deep frying compartment 107 to a first access aperture 111 which may be positioned on a side of the cooking housing 101 to allow access to a conveyor cavity 113.

FIG. 8 illustrates a perspective view of the cooking plate 131 which may include a upward extending peripheral edge 151 which may extend around the two sides and back of the cooking plate 131. FIG. 8 additionally illustrates a connection device 153 which may include a substantially J shaped hook to connect to the second endless belt 119.

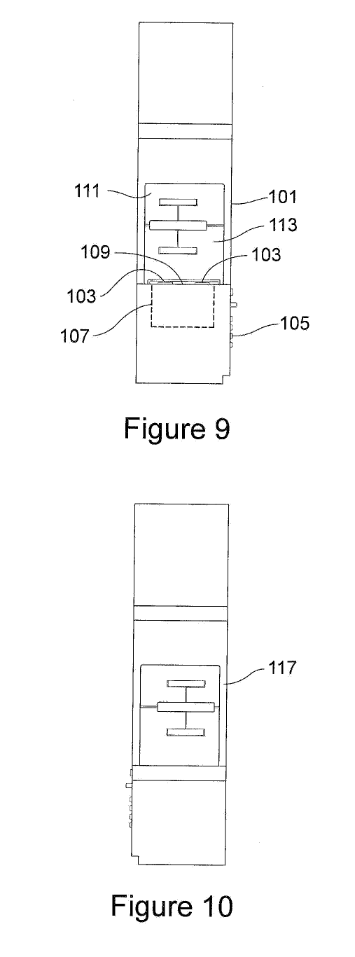

FIG. 9 illustrates a first side view of the cooking system 100 of the present invention which may include a cooking housing 101 which may support burner units 103 which may be controlled by burner controls 105 which may regulate the amount of gas or electricity supplied to the burner units 103. The cooking housing 101 may include deep frying compartments 107 which may cooperate with a deep frying pan to deep fry foods such as french fries, chicken or other fried foods. The cooking system 100 may include a conveyor grill 109 which may extend from the deep frying compartment 107 to a first access aperture 111 which may be positioned on a side of the cooking housing 101 to allow access to a conveyor cavity 113.

FIG. 9 additionally illustrates the first endless conveyor belt 115 and the second endless conveyor belt 119.

FIG. 10 illustrates the second side view of the cooking housing 101 and illustrates the second access aperture 117. FIG. 10 additionally illustrates the first endless conveyor belt 115 and the second endless conveyor belt 119.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A cooking system for cooking food, comprising:
a cooking housing to house the cooking system;
a conveyor cavity being defined by the cooking housing;
a first endless conveyor belt being within the conveyor cavity;
a second endless conveyor belt being within the conveyor cavity to cooperate with the first endless conveyor belt.

2) A cooking system for cooking food as in claim 1, wherein the second endless conveyor belt includes a cooking plate which may cooperate with the first endless conveyor belt to transfer the food between the first endless conveyor belt and the cooking plate of the second endless conveyor belt.

3) A cooking system for cooking food as in claim 1, wherein the cooking system includes a first burner.

4) A cooking system for cooking food as in claim 1, wherein the cooking system includes a deep frying compartment.

5) A cooking system for cooking food as in claim 1, wherein the cooking system includes a conveyor grill.

6) A cooking system for cooking food as in claim 1, wherein the cooking housing includes a first access aperture to access the conveyor cavity.

7) A cooking system for cooking food as in claim 6, wherein the cooking housing includes a second access aperture to access the conveyor cavity.

8) A cooking system for cooking food as in claim 1, wherein the cooking system includes an auxiliary oven.

9) A cooking system for cooking food as in claim 1, wherein the coding system includes a warmer oven.
